(19) United States
(12) Patent Application Publication
(10) Pub. No.: US 2024/0320882 A1
(43) Pub. Date: Sep. 26, 2024

(54) CHARACTER STRING RENDERING ON A DISPLAY

(71) Applicant: Ford Global Technologies, LLC, Dearborn, MI (US)

(72) Inventors: Itzel Hannelore Ocampo Valadez, Mexico City/Mexico City (MX); Saúl Moreno Motte, Mexico/CDMX (MX)

(73) Assignee: Ford Global Technologies, LLC, Dearborn, MI (US)

(21) Appl. No.: 18/679,799

(22) Filed: May 31, 2024

Related U.S. Application Data
(63) Continuation-in-part of application No. 18/050,191, filed on Oct. 27, 2022.

(51) Int. Cl. G06T 11/20; G06F 40/109; G06F 40/58

(52) U.S. Cl. CPC G06T 11/203; G06F 40/109; G06F 40/58

(57) ABSTRACT

A system includes a processor and a memory for storing instructions executable by the processor to receive a parameter from the memory that includes an identifier representing a variable font, a weight of the variable font, and a width of the variable font. The instructions can additionally be to compute a pixel length of a received first character string to be rendered via a display utilizing the identified variable font, the weight of the variable font, and the width of the variable font and to control the display to render the received first character string based on the identifier of the variable font, the weight of the variable font, or the width of the variable font.

### CROSS-REFERENCE TO RELATED APPLICATIONS

This application is a continuation-in-part of U.S. patent application Ser. No. 18/050,191, entitled “STRING SIZING NETWORK SERVICE,” filed Oct. 27, 2022. The contents of the afore-mentioned U.S. patent application is hereby incorporated herein by reference in its entirety.

### BACKGROUND

Vehicles can be equipped with displays to provide text messages to vehicle occupants. Different vehicles can have different displays with different display characteristics. The text messages shown on displays may be in various languages, fonts, and sizes. The rendering of text on the different displays and the various messages to be displayed on a human-machine interface (HMI) could be enhanced.

### BRIEF DESCRIPTION OF THE DRAWINGS

FIG. 1 shows an example system for rendering text on a display.

FIG. 2 shows an example character string library of text for rendering on a display.

FIG. 3A shows an example specification for a character string utilizing a static font.

FIG. 3B shows an example set of parameters for specifying a variable font.

FIG. 4 is a flowchart for an example process for rendering a character string on a display.

FIG. 5 is a flowchart for an example process for rendering a character string utilizing a variable font.

### DETAILED DESCRIPTION

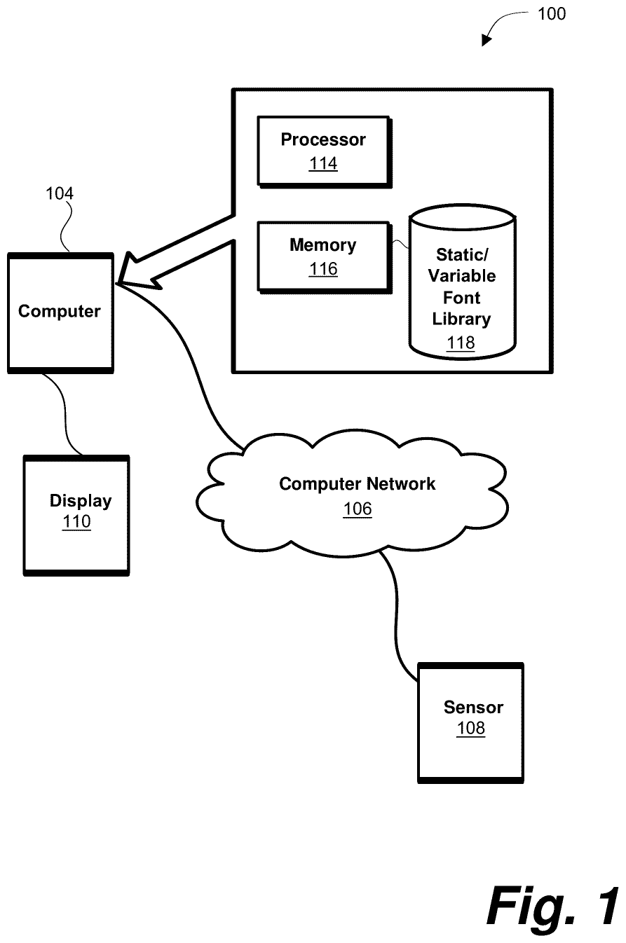

Throughout the description reference is made to FIGS. 1-8. In referring to the Figures, like structures and elements shown throughout are indicated with like reference numerals.

Described herein are methods and systems for rendering a character string on a display which can include, for example, a display included in a dashboard of a vehicle, or a display of any other system, such as a security and control system, an automated industrial system, etc. Implementations described herein can determine the length of a character string for display, e.g., the pixel width of a character-based message, to be displayed utilizing a static font or a variable font. In an example, a variable font can be specified utilizing a first axis, which can indicate a weight, e.g., hairline, regular, bold, extra bold, etc., of the lines that form the characters of the variable font. A variable font can be further specified utilizing a second axis, which can indicate a width, e.g., condensed, regular, wide, extra wide, of the characters of a character set utilized to display a character string via a constrained display area. As used herein, a “character string” means a succession of characters of an alphabet or other writing system, which are organized to convey a message. Thus, as an example, a “character string” can include one or more numbers, letters, words, or phrases in the English language utilizing the English alphabet or the ASCII character set, one or more numbers, words, or phrases in the German alphabet (including diacritical marks), one or more numbers, words, or phrases in the Arabic language utilizing the Abjad alphabet, etc. As used herein, “character string computation” means determining a number of pixels in the horizontal or vertical dimension of a display that are consumed in rendering a character string. Thus, as an example, an arrangement of characters of a writing system rendered using a light or hairline font consumes fewer pixels than an arrangement of the same characters of the writing system rendered using a bold or extra bold font.

As described herein, character string length computation, which may follow translation from a first language to a second language, and/or transliteration from a first character set to a second character set, can be achieved with reduced time and decreased consumption of computational resources. In an example, based on a character string length being computed to consume a pixel length (e.g., a number of pixels in a horizontal dimension) that is greater than an available display width, a variable font can be reduced in size utilizing fewer memory and computational resources than would be used in connection with use of a static font. In another example, based on a string length being computed to consume a greater pixel height (e.g., a number of pixels in a vertical dimension) that is greater than an available display height, variable font can be reduced in size so as to be accommodated by the available display area.

Accordingly, included in the present disclosure are example systems, such as systems that include a processor and a memory that can store instructions executable by the processor to receive one or more parameters from the memory that include an identifier representing a variable font name, a weight of the variable font, and a width of the variable font. The instructions may include instructions to compute a pixel length of a received first character string to be rendered via a display utilizing the identified variable font, the weight of the variable font, and the width of the variable font. The instructions can include instructions to control the display to render the received first character string based on the identifier of the variable font, the weight of the variable font, or the width of the variable font.

In an example, the instructions to control the display can include instructions to obtain an available number of pixels in a horizontal dimension of the display and to translate the received first character string from a first language to a second language.

The instructions can include instructions to be to modify the weight of the variable font or the width of the variable font based on the computed pixel length of the translated character string exceeding the available number of pixels in the horizontal dimension.

The instructions to control the display can include instructions to obtain an available number of pixels in a vertical dimension of the display, translate the received first character string from a first language to a second language and to modify the weight of the variable font or the width of the variable font based on the computed pixel length of the translated character string exceeding the available number of pixels in the vertical dimension.

The instructions to control the display can include instructions to obtain an available number of pixels in a horizontal dimension of the display and to transliterate the received first character string from a first character set to a second character set, and to modify the weight of the variable font or the width of the variable font based on the computed pixel length of the transliterated character string exceeding the available number of pixels in the horizontal dimension.

The instructions to control the display can include instructions to obtain an available number of pixels in a vertical dimension of the display, to transliterate the first character string from a first language to a second language, and to modify the weight of the variable font or the width of the variable font based on the computed pixel length of the transliterated character string exceeding the available number of pixels in the vertical dimension.

The instructions can include instructions to generate an instance of the weight of the variable font that is between endpoints of a first range of permissible weights for the variable. The instructions can include instructions to store the generated instance in the memory and to control the display to render a second received character string based on the generated instance.

The instructions can include instructions to generate an instance of the width of the variable font that is between endpoints of a second range of permissible widths for the variable font. The instructions can include instructions to store the generated instance in the memory and to control the display to render a second received character string based on the generated instance.

In an example, the computer and the memory can be included in a vehicle.

In an example, a method can include receiving a parameter from a memory that includes an identifier representing a variable font, a weight of the variable font, and a width of the variable font the method can include computing a pixel length of a received first character string to be rendered via a display utilizing the identified variable font, the weight of the variable font, and the width of the variable font. The instructions can include controlling the display to render the received first character string based on the identifier of the variable font, the weight of the variable font, or the width of the variable font.

In an example, the method can include obtaining an available number of pixels in a horizontal dimension of the display, translating the received first character string from a first language to a second language, and modifying the weight of the variable font or the width of the variable font based on the computed pixel length of the translated character string exceeding the available number of pixels in the horizontal dimension.

In an example, the method can include obtaining an available number of pixels in a vertical dimension of the display, translating the received first character string from a first language to a second language, and modifying the weight of the variable font or the width of the variable font based on the computed pixel length of the translated character string exceeding the available number of pixels in the vertical dimension.

In an example, the method can include obtaining an available number of pixels in a horizontal dimension of the display, transliterating the received first character string from a first character set to a second character set, and modifying the weight of the variable font or the width of the variable font based on the computed pixel length of the transliterated character string exceeding the available number of pixels in the horizontal dimension.

In an example, the method can include obtaining form the memory, an available number of pixels in a vertical dimension of the display, transliterating the first character string from a first language to a second language, and modifying the weight of the variable font or the width of the variable font based on the computed pixel length of the transliterated character string exceeding the available number of pixels in the vertical dimension.

In an example, the method can include generating an instance of the weight of the variable font that is between endpoints of a first range of permissible weights for the variable font, storing the generated instance in the memory, and controlling the display to render a second received character string based on the generated instance.

In an example, the method can include generating an instance of a width of the variable font that is between endpoints of a second range of permissible widths for the variable font, storing the generated instance in the memory, and controlling the display to render a second received character string based on the generated instance.

In an example, the system can be included in a vehicle.

FIG. 1 shows an example system 100 for rendering text on a display. System 100 can allow an HMI to display a character string so as to accommodate a character string using an available area of display 110. System 100 includes computer 104, which may represent a computer included in a vehicle, or another computer that performs general or special purpose processing to guide or assist in the operation of another type of system (e.g., an industrial system, a security and control system, etc.). Computer 104 can be coupled to a variety of sensors, such as sensor 108. Accordingly, sensor 108 can represent one or more camera sensors, radar sensors, lidar sensors, navigation and/or positioning sensors, torque sensors, heat sensors, accelerometers, etc., or combinations of sensor types.

Computer 104 may operate system 100 based on data received from sensors 108 and actuate components, such as components of a vehicle (e.g., steering components, propulsion components electrical and/or electrohydraulic components, climate control, internal and external lighting, etc.). Computer 104 can additionally determine whether and when computer 104, as opposed to a human operator, is to control such operations. Computer 104 can include a processor 114 and memory 116. Memory 116 can include one or more forms of nonvolatile computer-readable media, which stores instructions executable by the processor for performing various operations, including as disclosed herein. Computer 104 can be generally arranged for communications on any suitable type of communications network 106, i.e., including a controller area network (CAN), a local interconnect network (LIN), or another suitable communications bus architecture. Communications network 106 can include wired or wireless communication mechanisms such as are known, (i.e., Ethernet, Bluetooth, or another communication protocol).

Via communications network 106, computer 104 can transmit messages to various subsystems, components, and devices of system 100 and can receive messages from the various devices, subsystems, components, i.e., controllers, actuators, sensors, etc., including sensors 108. Alternatively or additionally, in examples in which vehicle computer 104 actually includes multiple devices, communications network 106 can be used for communications between devices represented as vehicle computer 104 in this disclosure. Further, as mentioned below, various controllers or sensing elements, such as sensors 108, can provide data to vehicle computer 104 via communications network 106.

System 100 can include a database such as static/variable font library 118 which may be accessible to computer 104. The term “library” is used herein to mean a database that stores and retrieves a grouping of data values that can be transmitted to computer 104 to control rendering of a character string utilizing display 110. Static/variable font library 118 can utilize a hierarchical, NoSQL, or other database technology known in the art. In an example, static/variable font library 118 can represent a database that is hosted and/or controlled by computer 104. In another example, static/variable font library 118 can be posted via a processor that is separate from computer 104, such as an HMI component of system 100.

In an example, computer 104 can generate a POST request to static/variable font library 118 that is formatted in JavaScript Object Notation (JSON). In another example, computer 104 can generate a request in another format, such as a GET request in an Extensible Markup Language (XML) data schema. In such an example, a request from computer 104 can include a string specification with a display text, a static font identifier, a static font size, and a display resolution.

In another example, computer 104 can generate a request for rendering a character string utilizing a variable font for display on display 110. In such an example, a request can include the name of an instance of a variable font. An instance generated by computer 104 can specify a variable font name (e.g., Madera Variable Font-Roman), or another type of identifier, along with first and second axes, such as a weight (first) axis and a width (second) axis. The term “weight axis” or “first axis” is used herein to mean a number of pixels consumed in generating a line of a character of an identified variable font. Thus, in an example, a weight (or first) axis of a line of a character to be rendered in regular (e.g., non-boldface) Madera Variable Font-Roman type can include a permissible weight axis range of between a first endpoint of 20 pixels and a second endpoint of 40 pixels. In another example, a weight of a line of a character to be rendered in a boldface Madera Variable Font-Roman type can include a permissible weight (or first) axis of between a first endpoint of 45 pixels and a second endpoint of 65 pixels. In another example, a weight of a line of a character to be rendered in extra boldface Madera Variable Font-Roman type can include a permissible weight (or first) axis of between a first endpoint of 70 pixels and a second endpoint of 120 pixels. The term “width axis” or “second axis” is used herein to mean a number of pixels consumed in generating a character of a character set. Thus, in an example, a width (or second) axis of an identified variable font can include a permissible width axis range of between a first endpoint of 30 pixels and a second endpoint of 40 pixels for a condensed or compressed typeface. In another example, a width (or second axis) of an identified variable font can include a permissible width axis range of between a first endpoint of 50 pixels and a second endpoint of 60 pixels for a narrow or regular typeface. In another example, a width (or second axis) of an identified variable font can include a permissible width axis range of between a first endpoint of 80 pixels and a second endpoint of 150 pixels for a wide or extended typeface.

In an example, in response to computer 104 generating a request for rendering a character string utilizing a static or variable font retrieved from static/variable font library 118, computer 104 can compute a number of pixels consumed by the rendered character string based on the retrieved static/variable font. In an example, based on the number of computed pixels being within or less than the available number of pixels in a first or horizontal dimension of display 110, computer 104 can direct display 110 to render the character string in a row of display 110. In another example, based on the number of computed pixels exceeding or being greater than the available number of pixels in the first or horizontal dimension of display 110, computer 104 can direct display 110 to render the character string by wrapping a portion of the character string so as to consume two or more rows of display 110. In another example, based on the number of computed pixels exceeding or being greater than the available number of pixels in the first or horizontal dimension of display 110, computer 104 can obtain a different (e.g., modified or reduced in pixel width) static or variable font from static/variable font library 118. Computer 104 can then recompute the number of pixels consumed by the rendered character string based on the modified or reduced pixel width so as to render the character string using, for example, a row of display 110.

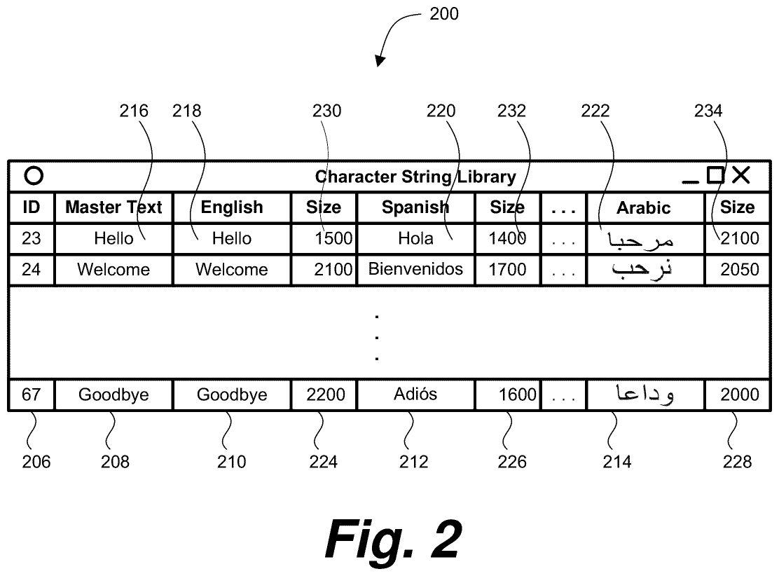

FIG. 2 shows an example character string library 200 of text for rendering on a display. In an example, computer 104 can translate a character string from a first language to a second language and/or to translate a character string from a first language to a plurality of languages. Computer 104 can include a pixel size of each of the translated texts. In addition, computer 104 can transliterate a character string from a first character set to a second character set such as from a character set of the English language to a character set of the Arabic language.

In another implementation, the memory 116 includes instructions to issue a query to static/variable font library 118 for a target font specified in the client request 120. A query can be formatted in a structured query language (SQL). Static/variable font library 118 can respond with a listing of static or variable font names, font locations, and font versions of a target font.

Based on a font version stored in static/variable font library 118 matching a font version specified in a request from computer 104, Computer 104 can include a selection of a font location associated with the font version in a database response from static/variable font library 118. Alternatively, responsive to no font version matching, computer 104 can select the font version and font location of the latest font version listed in static/variable font library 118. Computer 104 can then determine the size (i.e., pixel width in a horizontal dimension, pixel width in a vertical dimension) so as to compare a pixel width of a translated and/or transliterated character string with an available display area (e.g., display width in pixels, display height in pixels, etc.).

As shown in FIG. 2, computer 104 can generate character string library 200, which may include a spreadsheet, a listing viewable by an in-vehicle browser, and/or another database management system, for example. Character string library 200 can be utilized to display texts in different languages (e.g., English, Spanish, German, Arabic, etc.). In an example, character string library 200 can be specifically adapted to store messages in numerous languages for a user interface of an HMI in a vehicle display.

Character string library 200 includes record ID column 206 to identify each record or row in library 200. In an example, the record ID can be a numeric value, however, alpha-numeric identifiers may be used. In FIG. 2, three records are shown with record IDs of 23, 24 and 67.

Character string library 200 can include master text column 208, which includes text serving as a basis for text translations and/or transliterations from a first language to any of numerous other languages. Master text column 208 can include words, phrases, and/or paragraphs of text. In an example, computer 104 can detect the language of text entered in the master text column 208, e.g., using a suitable program or technique to detect a language of a text. For example, computer 104 may use a natural language application program interface (API) and/or a text analytics API to determine the language utilized to express a character string included in master text column 208. Alternatively, computer 104 can receive an input from a user, such as via an HMI, to specify a default language of the text in master text column 208.

Character string library 200 includes columns containing translations of the master display text into one or more respective languages, such as English column 210, Spanish column 212, and Arabic column 214. For example, in the row entry indicated by ID 23, master character string of cell 216 at master text column 208 includes “Hello,” English cell 218 in English column 210 also include “Hello,” Spanish cell 220 in Spanish column 212 include “Hola,” and Arabic cell 222 in Arabic column 214 include the transliteration for the English “Hello” in Arabic script (Abjad). It is contemplated that additional or alternative language columns may be present in character string library 200.

The language entries can be generated by computer 104. For example, upon entering text in a master text cell, Computer 104 may send a request to a translation service and fetch translations of the master text entry in various specified languages and/or a specified character set. Responsive to a translation and/or transliterated character string being received by computer 104, cells corresponding to each language can be populated into character string library 200 without user input. A user may override a generated translation and/or transliteration by manually entering a different translation and/or transliteration.

Each language column includes a corresponding string size column to store the pixel length of the character string representing the master text for display on display 110. For example, English column 224 includes English string pixel size column 230, Spanish column 226 includes Spanish pixel size column 232, Arabic column 228 includes Arabic pixel size column 234, etc. Values in string pixel size columns can be computed according to instructions executed on computer 104.

In an example, computer 104 can include instructions to send a request to an API, for example, based on a language cell being populated with an entry. A request can include a string specification, which can include use of a static or variable font to determine a pixel size of a character string for rendering on display 110.

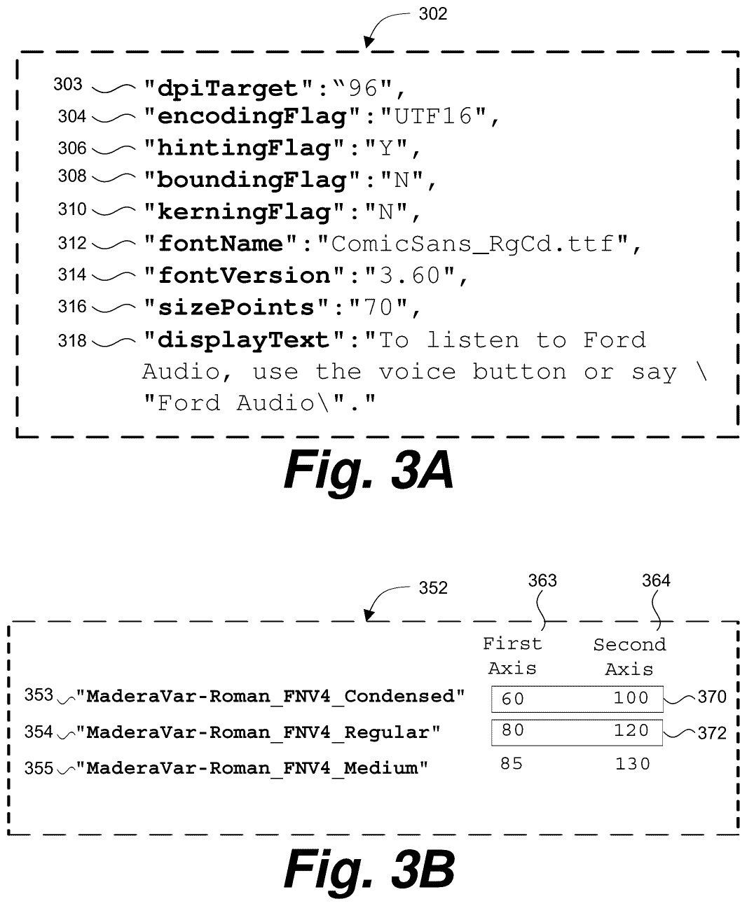

FIG. 3A shows an example specification for a character string utilizing a static font. In the example of FIG. 3A, string specification 302 is encoded in JSON and enclosed in a body of a HTTP POST request from computer 104. As discussed above, the string specification may be formatted in XML or another suitable data schema. In one configuration computer 104 can obtain a static font from static/variable font library 118 based on a character string utilizing a specified language entered in a language cell of character string library 200.

String specification 302, which can represent parameters to render a static font on display 110, can include display dots per inch (DPI) value 303. This value can indicate the display resolution of display 110. Typical values may be 72 or 96 for a static font. Encoding flag 304 indicates whether the string is encoded in UTF8 for Windows® based systems or UTF16 for Linux® based systems. Hinting flag 306 can be used to enable an internal static font mechanism to define glyphs at size points. Bounding flag 308 can specify measurement of a character string for rendering based on a surrounding box or a margin box in a given character string. Kerning flag 310 can indicate the space in between glyphs or characters of a character string. Kerning flag 310 can be dependent on whether the character string for display is being utilized for Latin-based languages or for transliteration into non-Latin based languages, such as Arabic, Chinese, etc. Font name value 312 can specify the static font file name that is to be used based on a measurement of horizontal length of a character string. Font version value 314 provides a working version of the font name. Font size value 316 indicates the size of the static font to be rendered on display 110. Display text 318 can represent a translation variant of a given master text character string in a given language, e.g., text present in master text column 208, that is to be measured by computer 104.

In an example, several translation variants of the master text may be specified in string specification 302. In such an example, string specification 302 can be structured as an array of objects, with each object indicating a different set of parameters for measuring the character string to be rendered on display 110. In an example, computer 104 can compute a pixel size of a character string for rendering.

FIG. 3B shows an example set of parameters 352 for specifying a variable font for use in rendering a character string. In the example of FIG. 3B, parameters 352 can be encoded in JSON and enclosed in a body of a HTTP POST request from computer 104. Alternatively, as discussed above, parameters 352 may be formatted in XML or other suitable data schema. In one configuration, computer 104 can obtain a variable font from static/variable font library 118 based on a character string utilizing a specified language entered in a language cell of character string library 200.

In the example of FIG. 3B, a variable font specifier includes field 353, which indicates the name of the variable font, e.g., “Madera Var-Roman_FNV4_Condensed.” The example of FIG. 3B also includes field 354, which indicates the name of variable font “Madera Var-Roman_FNV4_Regular,” and field 355 indicating the name of variable font “Madera Var-Roman_FNV4_Medium.” Rows of the example of FIG. 3B can be extended to include numerous names of variable fonts, such as dozens of variable fonts, hundreds of variable fonts, etc.

Variable fonts named via fields 353, 354, and 355 of FIG. 3B can each include first axis 363, which can represent the weight of a named variable font, and a second axis, which may represent the width of a named variable font. Thus, as shown at row 1, the variable font named “Madera Var-Roman_FNV4_Condensed” has been specified as including a first axis (weight) to indicate that 60 pixels are to be consumed in rendering lines of characters for display on display 110. Also as shown in row 1, the variable font named “Madera Var-Roman_FNV4_Condensed” has been specified as including a second axis (width) to indicate that 100 pixels are to be consumed in rendering characters for display on display 110.

Row 2 of FIG. 3B shows that the variable font named “Madera Var-Roman_FNV4_Regular” has been specified as including a first axis (weight) to indicate that 80 pixels are to be consumed in rendering lines of characters for display on display 110. Also as shown at row 2, the variable font named “Madera Var-Roman_FNV4_Regular” has been specified as including a second axis (width) to indicate that 120 pixels are to be consumed in rendering characters for display on display 110. Row 3 of FIG. 3B shows that the variable font named “Madera Var-Roman FNV4_Medium” has been specified as including a first axis (weight) to indicate that 85 pixels are to be consumed in rendering lines of characters for display on display 110. Also as shown at row 3, the variable font named “Madera Var-Roman FNV4_Medium” has been specified as including a second axis (width) to indicate that 130 pixels are to be consumed in rendering characters for display on display 110.

First axis 363 and second axis 364 can be aggregated to form an “instance” of a named variable font. Thus, in the example of FIG. 3B, a first axis of 60 and a second axis of 100 can be combined to form instance 370. As used herein, an “instance” means a specified first (or weight) axis and a second (or width) axis of a named variable font. Accordingly, in response to computer 104 requesting “Madera Var-Roman_FNV4_Condensed” from static/variable font library 118, the library can return the requested font instance, having a first (or weight) axis of 60 and a second (or width) axis of 100. Likewise, in response to computer 104 requesting “Madera Var-Roman_FNV4_Regular” from static/variable font library 118, library 118 can return the requested font instance, having a first (or weight) axis of 80, and a second (or width) axis of 120, which can be represented by instance 372.

It may be appreciated that by specifying a variable font via a name (e.g., field 353), a first axis (363), and a second axis (364), in which the first and second axes combine to form an instance, a variable font can be accessed from static/variable font library 118 utilizing a reduced number of parameters, such as parameters utilized to specify a static font via the string specification (302) of FIG. 3A. For example, as shown in FIG. 3B, first axis 363 and second axis 364, for use with variable fonts, can replace DPI value 303, encoding flag 304, hinting flag 306, bounding flag 308, kerning flag 310, font version value 314, and font size value 316, thereby consuming fewer memory resources of static/variable font library 118 than those consumed to store parameters of static fonts. Further, by specifying a variable font name in accordance with FIG. 3B, computer 104 can control rendering character strings using reduced computing resources than those consumed for rendering character strings that utilize static fonts.

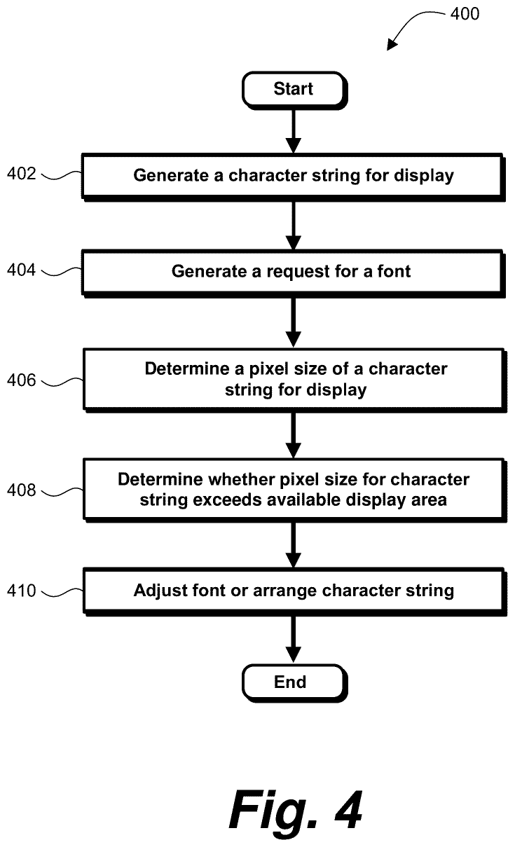

FIG. 4 is a flowchart for an example process 400 for rendering a character string on a display. In an example, computer 104 may obtain a character string for display on display 110. Computer 104 can utilize a natural language API and/or a text analytics API to determine the language utilized to express a character string included in master text column 208. Alternatively, computer 104 can receive an input from a user, such as via an HMI, to specify a default language of master text. Computer 104 may then interact with static/variable font library 118 to select a suitable font for rendering on display 110. Based on a selected static or variable font, computer 104 may determine a pixel size to be used for rendering the character string. In response to the pixel size of the character string exceeding an available area (e.g., in horizontal and vertical dimensions), computer 104 can adjust placement of portions of the character string such as, for example, to wrap text from a first row of characters to a second row of characters so as to display all characters of the character string.

Process 400 begins at block 402, which includes computer 104 generating a character string for display. In an example, Computer 104 may generate a character string in the English language based on output signals from sensors 108. Such sensors may provide, for example, position information that is utilized to provide driving directions to guide a vehicle to a destination or may be used to provide any other text-based notification that can be presented to an operator of the vehicle. In another example, a character string may be translated or transliterated to a non-English character set for display to a vehicle operator.

Process 400 continues at block 404, which includes computer 104 executing instructions to generate a request for a static or variable font that is to be utilized to render the character string on display 110. Block 404 may include computer 104 generating a request for a suitable font from static/variable font library 118.

Process 400 continues at block 406, which includes computer 104 executing instructions to compute a pixel size for rendering the character string utilizing the static or variable font obtained from static/variable font library 118. In an example, computer 104 may access a database or other type of listing (e.g., character string library 200) to determine a number of pixels in horizontal and/or vertical dimensions that are to be consumed in rendering the character string utilizing the font obtained from static/variable font library 118.

Process 400 continues at block 408, which includes computer 104 executing instructions to determine whether the pixel size for a character string, such as determined at block 406, exceeds an area available for display on display 110. Block 408 can include determining an available display area in horizontal and/or vertical dimensions.

Process 400 continues at block 410, which includes computer 104 executing instructions to obtain a different font from static/variable font library 118 for rendering a character string based on the pixel size for a character string exceeding an available display area in one or more dimensions. In another example, computer 104 can control display 110 so as to wrap text of a character string from a first line to a second line of the display so as to render all characters of the character string.

After executing block 410, process 400 ends.

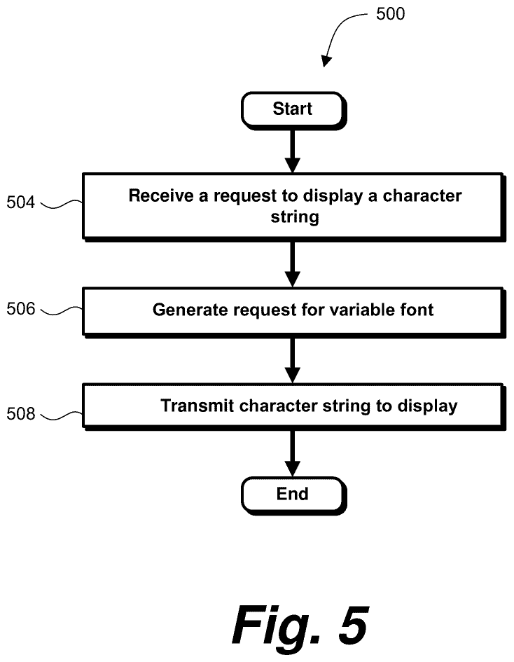

FIG. 5 is a flowchart for an example process 500 for rendering a character string utilizing a variable font on a display. In an example, computer 104 may receive a request, such as from an HMI of a vehicle, to display a character string. Computer 104 may generate a request for a variable font, which can be transmitted to static/variable font library 118. Based on the request for the variable font, static/variable font library 118 may access a suitable variable font. Static/variable font library 118 can transmit an instance of a font, such as a name of a suitable variable font, the weight or first axis of the variable font, the width or second axis of the variable font, etc. Based on receipt of parameters specifying the variable font, computer 104 can compute a pixel length of the character string based on the name of the variable font, the weight or first axis of the variable font, the width or second axis of the variable font, etc. Computer 104 can then control display 110 to render the variable font.

Process 500 begins at block 504, which includes computer 104 receiving a request to display a character string. A request may be transmitted from, for example, a vehicle onboard system, such as an HMI, a navigation system, and infotainment system, or another computing component of a system.

Process 500 continues at block 506, which includes computer 104 executing instructions to generate a request for a variable font. Such request may be transmitted to a variable font library, such as static/variable font library 118. Static/variable font library 118 may respond to such request by transmitting parameters specifying a suitable variable font, which can include a font name, the weight or first axis of the variable font, the width or second axis of the variable font, etc. A character string may be a translated or transliterated character string determined based on an interaction with a natural language API and/or a text analytics API to determine the language utilized to express a character string included in master text column 208.

Process 500 continues at block 508, which includes computer 104 executing instructions to transmit a character string for rendering at display 110 utilizing the named variable font, the weight or first axis of the variable font, the width or second axis of the variable font, etc.

After executing block 508, process 500 ends.

The descriptions of the various examples and implementations have been presented for purposes of illustration but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical enhancements over technologies found in the marketplace, or to enable others of ordinary skill in the art to understand the implementations disclosed herein.

As will be appreciated, the methods and systems described may be implemented as a computer program product. The computer program product may include a computer readable storage medium (or media) having computer readable program instructions thereon for causing a processor to carry out operations discussed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry.

Various implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system comprising a computer including a processor and memory, the memory storing instructions executable by the processor to:
receive a parameter from the memory that includes an identifier representing a variable font, a weight of the variable font, and a width of the variable font;
compute a pixel length of a received first character string to be rendered via a display utilizing the identified variable font, the weight of the variable font, and the width of the variable font; and
control the display to render the received first character string based on the identifier of the variable font, the weight of the variable font, or the width of the variable font.

2. The system of claim 1, wherein the instructions to control the display include instructions to:
obtain an available number of pixels in a horizontal dimension of the display;
translate the received first character string from a first language to a second language; and
modify the weight of the variable font or the width of the variable font based on the computed pixel length of the translated character string exceeding the available number of pixels in the horizontal dimension.

3. The system of claim 1, wherein the instructions to control the display include instructions to:
obtain an available number of pixels in a vertical dimension of the display;
translate the received first character string from a first language to a second language; and
modify the weight of the variable font or the width of the variable font based on the computed pixel length of the translated character string exceeding the available number of pixels in the vertical dimension.

4. The system of claim 1, wherein the instructions to control the display include instructions to:
obtain an available number of pixels in a horizontal dimension of the display;
transliterate the received first character string from a first character set to a second character set; and
modify the weight of the variable font or the width of the variable font based on the computed pixel length of the transliterated character string exceeding the available number of pixels in the horizontal dimension.

5. The system of claim 1, wherein the instructions to control the display include instructions to:
obtain an available number of pixels in a vertical dimension of the display;
transliterate the first character string from a first language to a second language; and
modify the weight of the variable font or the width of the variable font based on the computed pixel length of the transliterated character string exceeding the available number of pixels in the vertical dimension.

6. The system of claim 1, wherein the instructions further include instructions to:
generate an instance of the weight of the variable font that is between endpoints of a first range of permissible weights for the variable font;
store the generated instance in the memory; and
control the display to render a second received character string based on the generated instance.

7. The system of claim 1, wherein the instructions further include instructions to:
generate an instance of the width of the variable font that is between endpoints of a second range of permissible widths for the variable font;
store the generated instance in the memory; and
control the display to render a second received character string based on the generated instance.

8. The system of claim 1, wherein the computer and the memory are included in a vehicle.

9. A method, comprising:
receiving a parameter from a memory that includes an identifier representing a variable font, a weight of the variable font, and a width of the variable font;
computing a pixel length of a received first character string to be rendered via a display utilizing the identified variable font, the weight of the variable font, and the width of the variable font; and
controlling the display to render the received first character string based on the identifier of the variable font, the weight of the variable font, or the width of the variable font.

10. The method of claim 9, further comprising:
obtaining an available number of pixels in a horizontal dimension of the display;
translating the received first character string from a first language to a second language; and
modifying the weight of the variable font or the width of the variable font based on the computed pixel length of the translated character string exceeding the available number of pixels in the horizontal dimension.

11. The method of claim 9, further comprising:
obtaining an available number of pixels in a vertical dimension of the display;
translating the received first character string from a first language to a second language; and
modifying the weight of the variable font or the width of the variable font based on the computed pixel length of the translated character string exceeding the available number of pixels in the vertical dimension.

12. The method of claim 9, further comprising:
obtaining an available number of pixels in a horizontal dimension of the display;
transliterating the received first character string from a first character set to a second character set; and
modifying the weight of the variable font or the width of the variable font based on the computed pixel length of the transliterated character string exceeding the available number of pixels in the horizontal dimension.

13. The method of claim 9, further comprising:
obtaining form the memory, an available number of pixels in a vertical dimension of the display;
transliterating the first character string from a first language to a second language; and
reducing the weight of the variable font or the width of the variable font based on the computed pixel length of the transliterated character string exceeding the available number of pixels in the vertical dimension.

14. The method of claim 9, further comprising:
generating an instance of the weight of the variable font that is between endpoints of a first range of permissible weights for the variable font;
storing the generated instance in the memory; and
controlling the display to render a second received character string based on the generated instance.

15. The method of claim 9, further comprising:
generating an instance of a width of the variable font that is between endpoints of a second range of permissible widths for the variable font;
storing the generated instance in the memory; and
controlling the display to render a second received character string based on the generated instance.

16. The method of claim 9, wherein the memory is included in a vehicle.
